(19) United States
(12) Patent Application Publication
(10) Pub. No.: US 2014/0059629 A1
(43) Pub. Date: Feb. 27, 2014

(54) TWO-WAY BROADCAST SERVICE PROVIDING SYSTEM AND METHOD INCLUDING MEDIA TRANSMISSION APPARATUS

(71) Applicant: Electronics and Telecommunications Research Institute, Daejeon (KR)

(72) Inventors: Seung-Hun OH, Gwangju (KR); Seok-Kap KO, Gwangju (KR); Sim-Kwon YOON, Gwangju (KR); Byung-Tak LEE, Suwon (KR); Young-Sun KIM, Daejeon (KR)

(21) Appl. No.: 13/919,941

(22) Filed: Jun. 17, 2013

(30) Foreign Application Priority Data
Aug. 23, 2012 (KR) 10-2012-0092481

(51) Int. Cl. H04N 21/61

(52) U.S. Cl. CPC H04N 21/6156
USPC 725/109

(57) ABSTRACT

Two-way broadcast service providing system and method including a media transmission apparatus are provided. The media transmission apparatus includes a data communication interface that receives participant media from at least one participant terminal via a communication network, a media conversion unit that converts the participant media received through the data communication interface in accordance with a broadcast media standard, and a broadcast interface that transmits the participant media converted through the media conversion unit to a broadcast apparatus so that the participant media is included in broadcast contents.

### CROSS-REFERENCE TO RELATED APPLICATION

This application claims the benefit under 35 U.S.C. §119(a) of a Korean Patent Application No. 10-2012-0092481, filed on Aug. 23, 2012, the entire disclosure of which is incorporated herein by reference for all purposes.

### BACKGROUND

1. Field

The following description relates to communication and broadcasting technologies, and more particularly, to two-way broadcast service technologies.

2. Description of the Related Art

As communication technologies are merged with the broadcast area that has provided broadcast services in one way, two-way broadcast services that can enable viewers to participate directly in the broadcasts through two-way communication with the viewers have been activated. In particular, technologies in which multimedia including videos and audios of the viewers are merged with the broadcasts have been activated.

In providing the two-way broadcast services, it is inefficient to apply two-way communication technologies directly to broadcast equipment. In the broadcast area, the broadcasts have been already provided using a plurality of cameras, and there are a large number of expensive equipment for selecting a camera and mix images, for example, camera switches or media mixers.

Since a large number of media have been mixed and broadcasted in terms of service, people in a studio may view broadcasts in which the media are mixed. However, there is no specialized equipment or effective alternative to obtain media for remote viewers.

A broadcasting station is presently obtaining participant media using a structure in which expensive broadcast equipment is brought to and installed in the homes of the participants to perform one-to-one communication with equipment of the broadcasting station for the two-way broadcast services. As a result, an expensive broadcast vehicle has to be moved in order to obtain the participant media, and the broadcasting station has to build the same number of equipment enabling one-to-one connection as the participants in order to receive a large number of participant media.

### SUMMARY

The following description relates to a system and method for providing two-way broadcast services that may simply implement two-way broadcast services with low costs without any change in a structure of broadcast equipment.

In one general aspect, a media transmission apparatus includes: a data communication interface that receives participant media from at least one participant terminal via a communication network; a media conversion unit that converts the participant media received through the data communication interface in accordance with a broadcast media standard; and a broadcast interface that transmits the participant media converted through the media conversion unit to a broadcast apparatus so that the participant media is included in broadcast contents.

Here, the data communication interface may include a plurality of network interfaces matched for each communication network, and determine the communication network and network interface to receive the participant media in accordance with a data communication environment.

In addition, the media conversion unit may divide the participant media received through the data communication interface into video media and audio media, and then convert the divided video and audio media into broadcast video media and broadcast audio media, respectively.

In addition, the data communication interface may streamingly receive the participant media from the at least one participant terminal in real-time, and the broadcast interface may streamingly transmit the participant media converted through the media conversion unit to the broadcast apparatus in real-time.

In addition, the media transmission apparatus may further include a session control unit that controls session connection and disconnection between the at least one participant terminal and the broadcast apparatus and obtains session information during the session connection to provide the obtained session information to the media conversion unit.

In addition, the media conversion unit may convert the participant media received through the data communication interface into the broadcast media using the session information transmitted from the session control unit.

In addition, the session information may include video media codec information, audio media codec information, and video resolution.

In addition, the media transmission apparatus may further include a participant control interface that receives a request for the session connection from the at least one participant terminal to transmit the received request to the session control unit, and requests the session connection from the participant terminal selected through the session control unit.

In another general aspect, a media transmission apparatus includes: a broadcast interface that receives broadcast contents including participant media from a broadcast apparatus; a media conversion unit that receives the broadcast contents including the participant media from the broadcast interface and converts the received broadcast contents in accordance with a data communication media standard; and a data communication interface that transmits the broadcast contents converted through the media conversion unit to a viewer terminal including a participant terminal via a communication network.

In still another general aspect, a two-way broadcast service providing system includes: at least one participant terminal that generates participant media; a media transmission apparatus that receives the generated participant media from the at least one participant terminal via a communication network, and converts the received participant media in accordance with a broadcast media standard to transmit the converted participant media to a broadcast apparatus; and the broadcast apparatus that generates broadcast contents including the participant media transmitted from the media transmission apparatus to provide broadcast services.

In yet another general aspect, a two-way broadcast service providing method using a media transmission apparatus includes: performing session connection with at least one participant terminal; receiving participant media from the at least one participant terminal via a communication network through a channel in which the session connection is performed; converting the received participant media in accordance with a broadcast media standard; and transmitting the converted participant media to a broadcast apparatus.

Other features and aspects will be apparent from the following detailed description, the drawings, and the claims.

### BRIEF DESCRIPTION OF THE DRAWINGS

FIG. 1 is a configuration diagram illustrating a two-way broadcast service providing system according to an embodiment of the present invention;

FIG. 2 is a detailed configuration diagram illustrating a media transmission apparatus according to an embodiment of the present invention;

FIG. 3 is a diagram illustrating a signal connection relationship between components for transmitting participant media and final broadcast contents using a media transmission apparatus according to an embodiment of the present invention; and

FIG. 4 is a flowchart illustrating a two-way broadcast service providing method according to an embodiment of the present invention.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

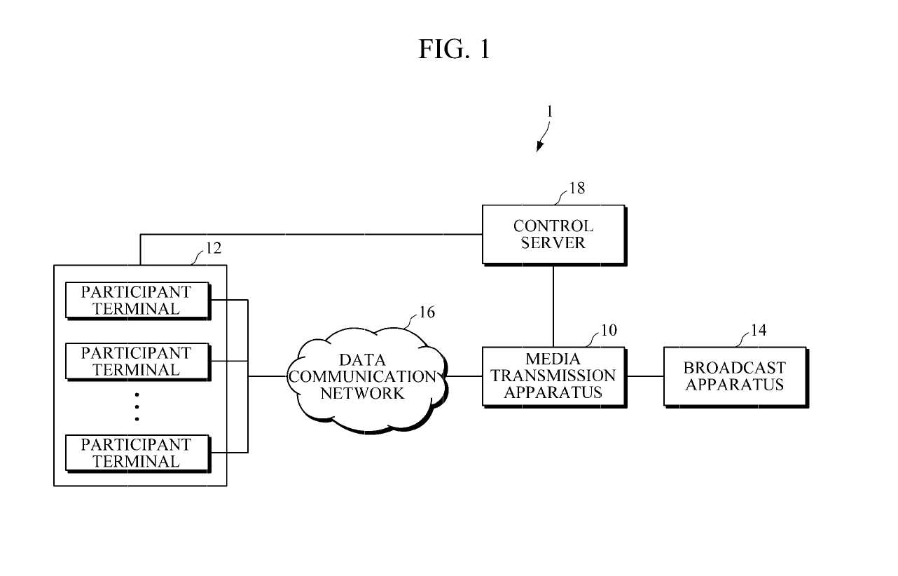

FIG. 1 is a configuration diagram illustrating a two-way broadcast service providing system according to an embodiment of the present invention.

Referring to FIG. 1, the two-way broadcast service providing system may include a media transmission apparatus 10, a participant terminal 12, and a broadcast apparatus 14, and further include a control server 18.

The participant terminal 12 is a device that receives two-way broadcast services from the broadcast apparatus 14, and a broadcast participant (hereinafter, referred to as “participant”) may participate in the two-way broadcast services through the participant terminal 12. The participants may be viewers that can participate in a broadcast among viewers viewing the broadcast. The participant may receive broadcast contents including media of the participant by participating in the broadcast. The participant media may be multimedia in which video, audio, and the like are combined. The participant terminal 12 may include shooting equipment for shooting a video and a microphone for receiving audio signals so as to provide media.

The participant terminal 12 may include home communication equipment that may receive broadcast signals and output the received broadcast signals. For example, the participant terminal 12 may include a television (TV), a personal computer, a PCTV, a set-top box, a mobile phone, a PMP, and the like. In addition, the participant terminal 12 may include shooting equipment for shooting a video by a participant to thereby produce media, and further include communication equipment for transmitting the media shot through the shooting equipment to the broadcast apparatus 14. A plurality of participant terminal 12 may be provided as shown in FIG. 1.

The broadcast apparatus 14 is a terminal that receives, produces, and re-transmits broadcast contents. The broadcast apparatus 14 may combine media to produce final broadcast contents, and enable participant media received from the participant terminal 12 to be included in the broadcast contents so as to provide the broadcast contents to viewers including the participant. For this, the broadcast apparatus 14 may select predetermined media and mix the selected media to produce the final broadcast contents.

According to the two-way broadcast services of the present invention, the participant terminal 12 may transmit the participant media to the broadcast apparatus 14 through the media transmission apparatus 10, and the broadcast apparatus 14 may enable the participant media provided from the participant terminal 12 to be included in the broadcast contents and then transmit the broadcast contents to the participant terminal 12 through the media transmission apparatus 10.

The media transmission apparatus 10 which is positioned between the participant terminal 12 and the broadcast apparatus 14 may obtain participant media from the participant terminal 12, convert the obtained participant media in accordance with a broadcast media standard, and transmit the converted participant media to the broadcast apparatus 14. Accordingly, the broadcast apparatus 14 may easily provide two-way broadcast services to viewers including broadcast participants while using existing broadcast equipment as is.

The media transmission apparatus 10 may use a variety of data communication networks 16 in order to obtain the participant media from the participant terminal 12. The media transmission apparatus 10 may include a network interface card (NIC) fitting the data communication network 16. In this instance, the participant media may include videos and audios, and since high-quality media is required in a general broadcast, the data communication network 16 and a network interface may be selected based on a data communication environment.

The media transmission apparatus may use a session initiation protocol (SIP) or a control protocol such as H.323 or RTCP so as to connect the participant terminal 12 and a media session. In this instance, a media session between the participant terminal 12 and the media transmission apparatus 10 may be opened with the help of the control server 18 so as to fit the used control protocol, so that the participant media may be transmitted to the broadcast apparatus 14. In some cases, the media session may be directly connected without the control server 18.

The media transmission apparatus 10 may convert the participant media transmitted from the participant terminal 12 through the data communication network 16 in accordance with a broadcast media standard, and then transmit the converted participant media to the broadcast apparatus 14 through a broadcast interface. Then, in the broadcast apparatus 14, the participant media may be selected and mixed through a broadcast editing process of engineers of a broadcasting station to thereby generate final broadcast contents, and the generated broadcast contents may be broadcasted to viewers including the participant.

That is, the media transmission apparatus 10 may transmit the final broadcast contents to the participants that have transmitted the media. For this, the media transmission apparatus 10 may streamingly receive the final broadcast contents from the broadcast apparatus 14, convert the streamingly received final broadcast contents in accordance with a standard required by the participant terminal 12, and then transmit the converted broadcast contents to the participant terminal 12. In this instance, a channel that transmits the broadcast contents to the participant terminal 12 may re-use a channel that is opened when the participant terminal 12 transmits the participant media to the media transmission apparatus 10.

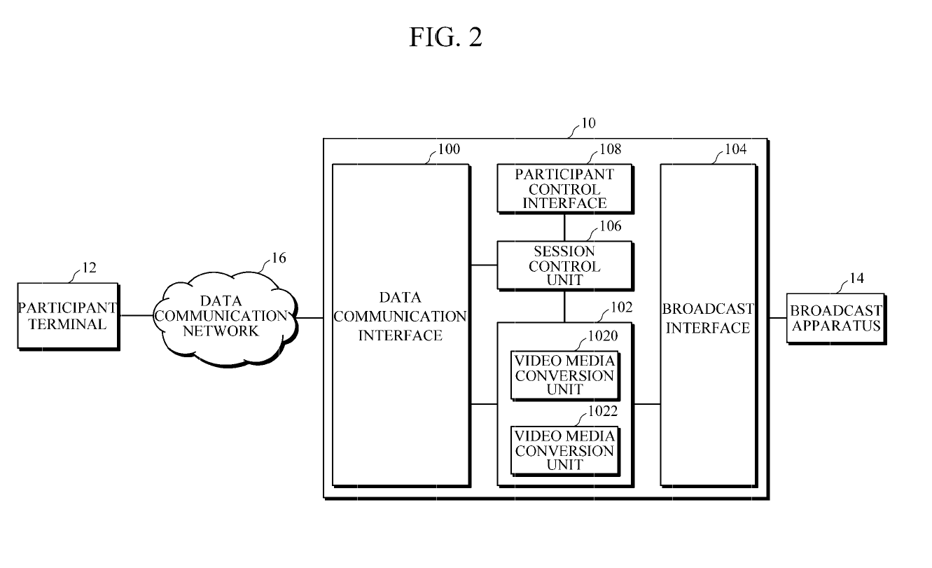

FIG. 2 is a detailed configuration diagram illustrating the media transmission apparatus 10 according to an embodiment of the present invention.

Referring to FIGS. 1 and 2, the media transmission apparatus 10 may include a data communication interface 100, a media conversion unit 102, and a broadcast interface 104, and further include a session control unit 106 and a participant control interface 108.

The media transmission apparatus 10 may receive participant media from the participant terminal 12, and transmit the received participant media to the broadcast apparatus 14.

Hereinafter, functions of each component for transmitting participant media of the media transmission apparatus 10 will be described.

The data communication interface 100 may receive participant media from the participant terminal 12 through the data communication network 16. The data communication interface 100 may be, for example, an Ethernet card, a wireless LAN card, a mobile communication modem, a WiMAX (worldwide interoperability for microwave access) modem, or the like. The data communication interface 100 may include a plurality of network interfaces matched for each communication network. In this instance, a communication network and a network interface to receive the participant media may be determined in accordance with a data communication environment. For example, the communication network and the network interface may be determined considering the number of participant terminals 12, a bandwidth, media processing capacity, and the like. The data communication interface 100 may streamingly receive the participant media from the participant terminal 12 in real-time.

The media conversion unit 102 may convert the participant media received through the data communication interface 100 in accordance with a broadcast media standard. The broadcast media standard may be, for example, HD-SDI (high definition-serial digital interface), SD-SDI (standard definition-serial digital interface), or the like.

According to an embodiment of the present invention, the media conversion unit 102 may include a video media conversion unit 1020 and an audio media conversion unit 1022. The video media conversion unit 1020 may separate video media from the participant media received through the data communication interface 100, and then convert the separated video media into broadcast video media. The audio media conversion unit 1022 may separate audio media from the participant media received through the data communication interface 100, and then convert the separated audio media into broadcast audio media.

The broadcast interface 104 may transmit the participant media converted through the media conversion unit 102 to the broadcast apparatus 14 so that the participant media may be included in the broadcast contents. The broadcast interface 104 may streamingly transmit the participant media converted through the media conversion unit 102 to the broadcast apparatus 14 in real-time.

The session control unit 106 may control session connection and session disconnection between the participant terminal 12 and the broadcast apparatus 14. Here, the session control unit 106 may obtain session information during the session connection, and provide the obtained session information to the media conversion unit 102. Then, the media conversion unit 102 may convert the participant media received through the data communication interface 100 into broadcast media using the session information transmitted from the session control unit 106.

The session information may include video media codec information, audio media codec information, and the like. The session information may include video resolution and the like supported by the participant terminal 12 as well as the codec information.

The participant control interface 108 may receive a request for session connection from the participant terminal 12, transmit the received request to the session control unit 106, and then request the session connection from the participant terminal selected through the session control unit 106. In order to obtain the participant media from the participant terminal 12, communication connection with participants should be controlled by broadcast engineers. The participant control interface 108 may perform control functions such as selecting participants desiring to obtain participant media to request session connection from the participants or terminating the session connection. For this, the participants may be registered in advance, or participant information may be registered by first trying to perform the session connection by the participants. Even though the session connection is terminated after the participant information is registered, it is possible to connect the participant and the session based on the registered session information again.

When a media communication channel is opened by the session control unit 106, the media transmission apparatus 10 may receive participant media from the participant terminal 12 through the data communication interface 100, convert the received participant media into broadcast media through the media conversion unit 102, and then transmit the converted participant media to the broadcast apparatus 14 through the broadcast interface 104.

Meanwhile, the broadcast apparatus 14 may produce final broadcast contents by mixing the participant media with the broadcast contents, and the media transmission apparatus 10 may receive the final broadcast contents from the broadcast apparatus 14 and transmit the received broadcast contents to the participant terminal 12.

Hereinafter, functions of each component for transmitting the final broadcast contents of the media transmission apparatus 10 will be described.

The broadcast interface 104 may receive broadcast contents including participant media from the broadcast apparatus 14. The media conversion unit 102 may receive the broadcast contents including the participant media from the broadcast interface 104, and convert the received broadcast contents in accordance with the data communication media standard. The data communication interface 100 may transmit the broadcast contents converted through the media conversion unit 102 to the viewer terminal including the participant terminal 12 through the data communication network 16.

The session control unit 106 may control session connection and disconnection between the participant terminal 12 and the broadcast apparatus 14, and obtain session information during the session connection to provide the obtained session information to the media conversion unit 102.

Next, the media conversion unit 102 may convert the broadcast contents received through the broadcast interface 104 in accordance with the data communication media standard using the session information received from the session control unit 106.

According to an embodiment of the present invention, when the session connection between the participant terminal 12 and the broadcast apparatus 14 is performed, the session control unit 106 may control the participant media to be transmitted to the broadcast apparatus 14 from the participant terminal 12 through a channel in which the session connection is performed, and control the broadcast contents including the participant media to be transmitted to the participant terminal 12 from the broadcast apparatus 14 through the channel in which the session connection is performed.

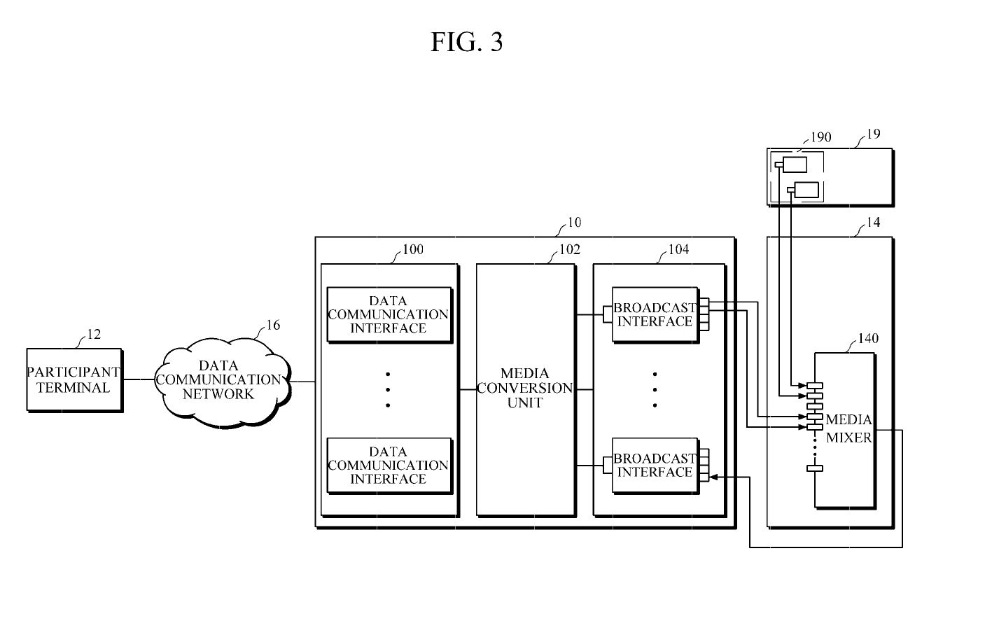

FIG. 3 is a diagram illustrating a signal connection relationship between components for transmitting participant media and final broadcast contents using the media transmission apparatus 10 according to an embodiment of the present invention.

Referring to FIG. 3, the media transmission apparatus 10 may receive participant media from the participant terminal 12 through the data communication interface 100. In this instance, the data communication interface 100 may include a plurality of network interfaces, and select a network interface suitable for a data communication environment to thereby receive the participant media. Next, the media transmission apparatus 10 may convert the participant media received through the data communication interface in accordance with the broadcast media standard through the media conversion unit 102, and transmit the converted participant media to the broadcast apparatus 14 through the broadcast interface 104.

When receiving the participant media from the participant terminal 12 through the media transmission apparatus 10, the broadcast apparatus 14 may produce final broadcast contents by mixing the received media with broadcast contents produced by the broadcast production apparatus 19.

The broadcasting apparatus 14 may include a media mixer 140 for producing the final broadcast contents, and the media mixer 140 may select participant media to be mixed with the broadcast contents provided from the broadcast production apparatus 19, and produce the final broadcast contents by mixing the selected participant media and the broadcast contents.

The broadcast production apparatus 19 may produce broadcast contents through a shooting device 190, and provide the produced broadcast contents to the broadcast apparatus 14. The broadcast apparatus 14 may transmit the final broadcast contents to the media transmission apparatus 10. Then, the media transmission apparatus 10 may receive the final broadcast contents from the broadcast interface 104, convert the final broadcast contents in accordance with the data communication media standard through the media conversion unit 102, and then transmit the converted broadcast contents to the participant terminal 12 through the data communication interface 100.

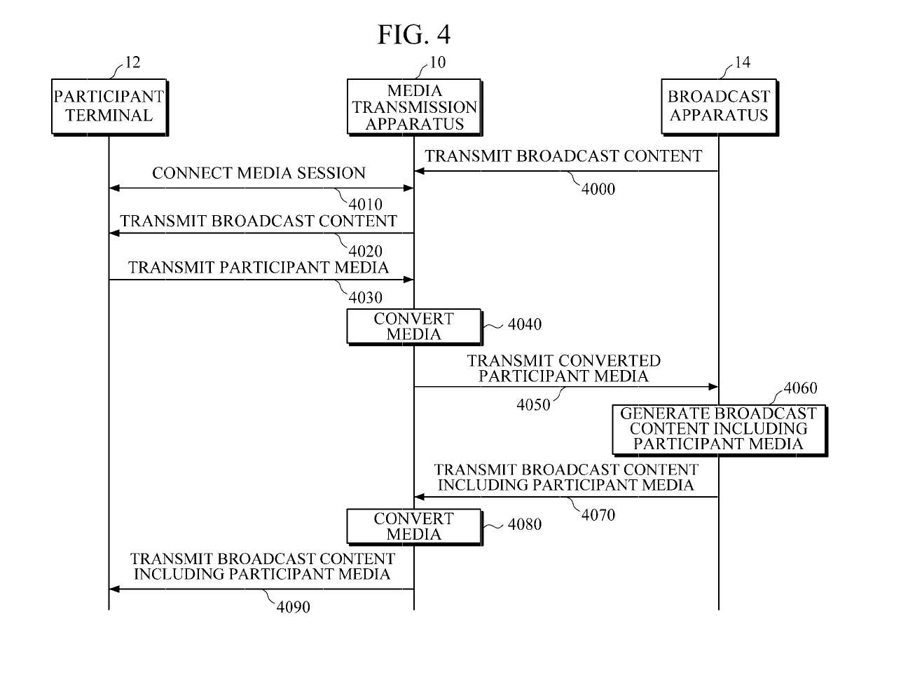

FIG. 4 is a flowchart illustrating a two-way broadcast service providing method according to an embodiment of the present invention.

Referring to FIG. 4, final broadcast contents sent from the broadcast apparatus 14 may be always transmitted to the media transmission apparatus 10. When a request for opening a multimedia session is transmitted by a participant or the media transmission apparatus, a received node may grant this.

As a result, in step 4010, a media channel is opened.

In step 4020, the broadcast contents that have been already transmitted may be streaming transmitted through the opened channel.

In addition, in step 4030, the participant media may be streaming transmitted to the media transmission apparatus through this channel.

The media transmission apparatus 10 may divide the participant media into videos and audios, convert the divided participant media in accordance with the broadcast media standard in step 4040, and then transmit the converted participant media to the broadcast apparatus 14 in step 4050.

In step 4060, when receiving the participant media from the participant terminal 12 through the media transmission apparatus 10, the broadcast apparatus 14 may produce final broadcast contents by mixing the participant media selected by engineers of the broadcasting station with the broadcast contents.

In step 4070, the final broadcast contents may be transmitted to the media transmission apparatus 10.

The media transmission apparatus 10 may convert the final broadcast contents received from the broadcast apparatus 14 in accordance with the data communication media standard in step 4080, and then transmit the converted final broadcast contents to the participant terminal 12 in step 4090.

As described above, according to the embodiments of the present invention, it is possible to simply provide two-way broadcast service to viewers including the broadcast participants with low costs without any change in a structure of the broadcast equipment. That is, the participant media received from the participant terminal through the media transmission apparatus may be transmitted to the broadcast apparatus, and the final broadcast contents including the participant media may be transmitted to the participant terminal, and therefore it is possible to easily implement two-way broadcast services with low costs without any change in the structure of the broadcast equipment while deviating from one-way broadcast services.

Therefore, the two-way broadcast services may be expected to be accelerated through the media transmission apparatus.

In addition, two-way broadcast equipment markets may be expected to be accelerated by addition of the participant media transmission apparatus.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A media transmission apparatus comprising:
a data communication interface that receives participant media from at least one participant terminal via a communication network;
a media conversion unit that converts the participant media received through the data communication interface in accordance with a broadcast media standard; and
a broadcast interface that transmits the participant media converted through the media conversion unit to a broadcast apparatus so that the participant media is included in broadcast contents.

2. The media transmission apparatus according to claim 1, wherein the data communication interface includes a plurality of network interfaces matched for each communication network, and determines the communication network and network interface to receive the participant media in accordance with a data communication environment.

3. The media transmission apparatus according to claim 1, wherein the media conversion unit divides the participant media received through the data communication interface into video media and audio media, and then converts the divided video and audio media into broadcast video media and broadcast audio media, respectively.

4. The media transmission apparatus according to claim 1, wherein the data communication interface streamingly receives the participant media from the at least one participant terminal in real-time, and
the broadcast interface streamingly transmits the participant media converted through the media conversion unit to the broadcast apparatus in real-time.

5. The media transmission apparatus according to claim 1, further comprising:
a session control unit that controls session connection and disconnection between the at least one participant terminal and the broadcast apparatus, and obtains session information during the session connection to provide the obtained session information to the media conversion unit.

6. The media transmission apparatus according to claim 5, wherein the media conversion unit converts the participant media received through the data communication interface into the broadcast media using the session information transmitted from the session control unit.

7. The media transmission apparatus according to claim 6, wherein the session information includes video media codec information, audio media codec information, and video resolution.

8. The media transmission apparatus according to claim 5, further comprising:
a participant control interface that receives a request for the session connection from the at least one participant terminal to transmit the received request to the session control unit, and requests the session connection from the participant terminal selected through the session control unit.

9. A media transmission apparatus comprising:
a broadcast interface that receives broadcast contents including participant media from a broadcast apparatus;
a media conversion unit that receives the broadcast contents including the participant media from the broadcast interface and converts the received broadcast contents in accordance with a data communication media standard; and
a data communication interface that transmits the broadcast contents converted through the media conversion unit to a viewer terminal including a participant terminal via a communication network.

10. The media transmission apparatus according to claim 9, further comprising:
a session control unit that controls session connection and disconnection between the participant terminal and the broadcast apparatus, and obtains session information during the session connection to provide the obtained session information to the media conversion unit.

11. The media transmission apparatus according to claim 10, wherein the media conversion unit converts the broadcast contents received through the broadcast interface in accordance with the data communication media standard using the session information transmitted from the session control unit.

12. The media transmission apparatus according to claim 10, wherein, when session connection between the participant terminal and the broadcast apparatus is performed, the session control unit controls the participant media to be transmitted from the participant terminal to the broadcast apparatus through a channel in which the session connection is performed, and controls the broadcast contents including the participant media to be transmitted from the broadcast apparatus to the participant terminal through the channel in which the session connection is performed.

13. A two-way broadcast service providing system, comprising:
at least one participant terminal that generates participant media;
a media transmission apparatus that receives the generated participant media from the at least one participant terminal via a communication network, and converts the received participant media in accordance with a broadcast media standard to transmit the converted participant media to a broadcast apparatus; and
the broadcast apparatus that generates broadcast contents including the participant media transmitted from the media transmission apparatus to provide broadcast services.

14. The two-way broadcast service providing system according to claim 13, wherein the broadcast apparatus includes a media mixer that synthesizes the participant media transmitted from the media transmission apparatus with the broadcast contents and provides the synthesized broadcast contents to a viewer terminal including the participant terminal.

15. A two-way broadcast service providing method using a media transmission apparatus, comprising:
performing session connection with at least one participant terminal;
receiving participant media from the at least one participant terminal via a communication network through a channel in which the session connection is performed;
converting the received participant media in accordance with a broadcast media standard; and
transmitting the converted participant media to a broadcast apparatus.

16. The two-way broadcast service providing method according to claim 15, further comprising:
receiving broadcast contents including the participant media from the broadcast apparatus;
converting the received broadcast contents including the participant media in accordance with a data communication media standard; and
transmitting the converted broadcast contents to the at least one participant terminal via the communication network.

17. The two-way broadcast service providing method according to claim 16, wherein the transmitting of the converted broadcast contents to the at least one participant terminal via the communication network includes transmitting the broadcast contents including the participant media from the broadcast apparatus to the at least one participant terminal via a channel through which the participant media is transmitted from the at least one participant terminal to the broadcast apparatus.
